(19) United States
(12) Patent Application Publication
(10) Pub. No.: US 2026/0301455 A1
(43) Pub. Date: Oct. 1, 2026

(54) METHOD AND SYSTEM FOR VALIDATING TEST REPORTS

(71) Applicant: HCL Technologies Limited, New Delhi (IN)

(72) Inventors: SivaSakthivel Sadhasivam, Chennai (IN); Narender Siddhamshetty, Hyderabad (IN); Srihari Varadharajan, Chennai (IN); Sri Gayathri Paaraa P, Chennai (IN); Nidhin A. Unnithan, Chennai (IN)

(21) Appl. No.: 19/457,195

(22) Filed: Jan. 23, 2026

(30) Foreign Application Priority Data
Mar. 31, 2025 (IN) 202511031863

(51) Int. Cl. G06V 30/196; G06V 30/146

(52) U.S. Cl. CPC G06V 30/1988; G06V 30/147

(57) ABSTRACT

This disclosure relates to method and system for validating test reports. The method may include receiving a test report and a corresponding data dump file from a data source. The data dump file may include data dump generated by the data source. The test report may include one or more report graphs and one or more report tables based on report data obtained from the data dump. The method may further include extracting report data from the test report using Computer Vision (CV) algorithms and a deep learning model. The method may further include validating the report data through a comparison with the data dump using the CV algorithms and the deep learning model.

### DESCRIPTION

### TECHNICAL FIELD

This disclosure relates generally to data analysis and validation, and more particularly to method and system for validating test reports.

### BACKGROUND

In various domains, such as medical, forensic, biostatistics, smart devices (energy, water in utilities domains), etc., monitoring devices are used to generate various reports showing results based on the collected data. Additionally, such a monitoring device may generate a dump data file (i.e., raw data) that may contain all transactional data in line with the report generated by the monitoring device for a given time period.

During testing of such monitoring devices, a test report generated from the device under test (i.e., the monitoring device) may be validated based on the data in the data dump file. The test report may include different types of graphs and tables to represent the data for the user (or consumer). Moreover, the table and graph may represent a direct value or an indirect value derived through arithmetic calculation from the data dump file.

Thus, manual validation of the generated test reports that contain complex plotting and tables may be challenging for testers. Pixel-level validation of the test report is not manually practical as the data is taken for a time duration and various symbols may be used to represent each data point in the test report. There is, therefore, a need in the present state of art for a techniques to accurately and efficiently validate the generated test report.

### SUMMARY

In one embodiment, a method for validating test reports is disclosed. In one example, the method may include receiving a test report and a corresponding data dump file from a data source. The data dump file may include data dump generated by the data source. The test report may include one or more report graphs and one or more report tables based on report data obtained from the data dump. The method may further include extracting the report data from the test report using Computer Vision (CV) algorithms and a deep learning model. Extracting the report data may include extracting graph data from each of the one or more report graphs using the CV algorithms based on pixel information of a report graph and a set of predefined parameter labels. The graph data may correspond to a plurality of graph elements. Each type of the plurality of graph elements may correspond to a predefined parameter label. Extracting the report data may further include extracting text data from each of the one or more report tables and each of the one or more report graphs using the deep learning model. The text data may correspond to a plurality of table text elements and a plurality of graph text elements. The method may further include validating the report data through a comparison with the data dump using the CV algorithms and the deep learning model. Validating the report data may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump. The extracted dataset may correspond to the report data.

In one embodiment, a system for validating test reports is disclosed. In one example, the system may include a processor and a memory communicatively coupled to the processor. The memory may store processor-executable instructions, which, on execution, may cause the processor to receive a test report and a corresponding data dump file from a data source. The data dump file may include data dump generated by the data source. The test report may include one or more report graphs and one or more report tables based on report data obtained from the data dump. The processor-executable instructions, on execution, may further cause the processor to extract the report data from the test report using CV algorithms and a deep learning model. To extract the report data, the processor-executable instructions, on execution, may cause the processor to extract graph data from each of the one or more report graphs using the CV algorithms based on pixel information of a report graph and a set of predefined parameter labels. The graph data may correspond to a plurality of graph elements. Each type of the plurality of graph elements may correspond to a predefined parameter label. To extract the report data, the processor-executable instructions, on execution, may further cause the processor to extract text data from each of the one or more report tables and each of the one or more report graphs using the deep learning model. The text data may correspond to a plurality of table text elements and a plurality of graph text elements. The processor-executable instructions, on execution, may further cause the processor to validate the report data through a comparison with the data dump using the CV algorithms and the deep learning model. To validate the report data, the processor-executable instructions, on execution, may cause the processor to validate, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump. The extracted dataset may correspond to the report data.

In one embodiment, a non-transitory computer-readable medium storing computer-executable instructions for validating test reports may be disclosed. In one example, the stored instructions, when executed by a processor, may cause the processor to perform operations including receiving a test report and a corresponding data dump file from a data source. The data dump file may include data dump generated by the data source. The test report may include one or more report graphs and one or more report tables based on report data obtained from the data dump. The operations may further include extracting the report data from the test report using CV algorithms and a deep learning model. For extracting the report data, the operations may include extracting graph data from each of the one or more report graphs using the CV algorithms based on pixel information of a report graph and a set of predefined parameter labels. The graph data may correspond to a plurality of graph elements. Each type of the plurality of graph elements may correspond to a predefined parameter label. For extracting the report data, the operations may further include extracting text data from each of the one or more report tables and each of the one or more report graphs using the deep learning model. The text data may correspond to a plurality of table text elements and a plurality of graph text elements. The operations may further include validating the report data through a comparison with the data dump using the CV algorithms and the deep learning model. For validating the report data, the operations may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump. The extracted dataset may correspond to the report data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for validating test reports, in accordance with some embodiments of the present disclosure.

FIG. 2 illustrates a functional block diagram of an exemplary system for validating test reports, in accordance with some embodiments of the present disclosure.

FIGS. 3A and 3B illustrate a flow diagram of an exemplary process for validating test reports, in accordance with some embodiments of the present disclosure.

FIG. 4 illustrates a flow diagram of an exemplary process for validating graph data and text data in report graphs, in accordance with some embodiments of the present disclosure.

FIG. 5A illustrates an exemplary test report, in accordance with some embodiments of the present disclosure.

FIG. 5B illustrates exemplary dump data, in accordance with some embodiments of the present disclosure.

FIG. 6 illustrates an exemplary validation report with successfully validated report data, in accordance with some embodiments of the present disclosure.

FIG. 7 illustrates an exemplary validation report with some unsuccessfully validated report data, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

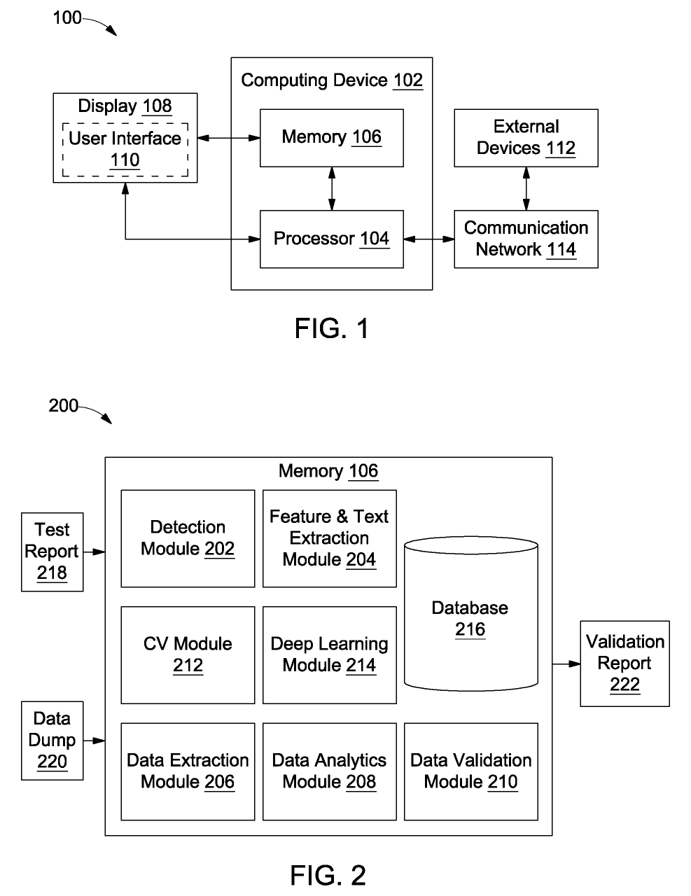

Referring now to FIG. 1, an exemplary system 100 for validating test reports is illustrated, in accordance with some embodiments of the present disclosure. The system may include a computing device 102 (for example, server, desktop, laptop, notebook, netbook, tablet, smartphone, mobile phone, or any other computing device), in accordance with some embodiments of the present disclosure. The computing device 102 may validate test reports generated by a Device Under Test (DUT) using Computer Vision (CV) algorithms and a deep learning model. By way of an example, the DUT may include, but may not be limited to, a medical device, a forensic device, a biostatistics device, any other smart device (e.g., smartwatch, biosensor, energy monitoring device, water monitoring device, etc.), or the like.

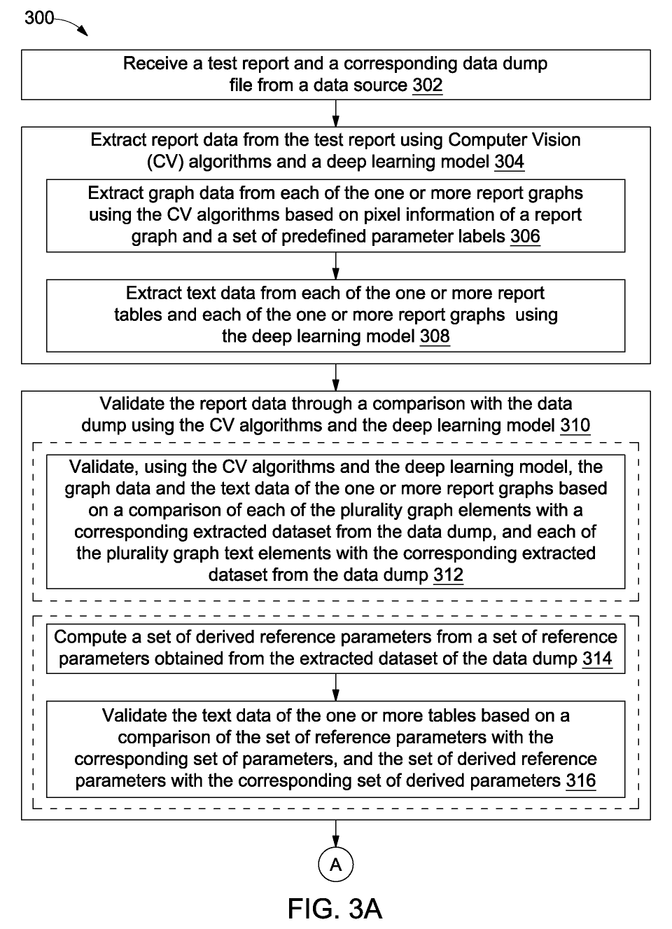

As will be described in greater detail in conjunction with FIGS. 2 – 7, the computing device 102 may receive a test report and a corresponding data dump file from a data source. The data dump file may include data dump generated by the data source. The test report may include one or more report graphs and one or more report tables based on report data obtained from the data dump. The computing device 102 may further extract the report data from the test report using CV algorithms and a deep learning model. Extracting the report data may include extracting graph data from each of the one or more report graphs using the CV algorithms based on pixel information of a report graph and a set of predefined parameter labels. The graph data may correspond to a plurality of graph elements. Each type of the plurality of graph elements may correspond to a predefined parameter label. Extracting the report data may further include extracting text data from each of the one or more report tables and each of the one or more report graphs using the deep learning model. The text data may correspond to a plurality of table text elements and a plurality of graph text elements. The computing device 102 may further validate the report data through a comparison with the data dump using the CV algorithms and the deep learning model. Validating the report data may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump. The extracted dataset may correspond to the report data.

In some embodiments, the computing device 102 may include one or more processors 104 and a memory 106. Further, the memory 106 may store instructions that, when executed by the one or more processors 104, cause the one or more processors 104 to validate test reports, in accordance with aspects of the present disclosure. The memory 106 may also store various data (for example, graph data, text data, data dump, CV algorithms data, deep learning model data, and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of an exemplary system 200 for validating test reports is illustrated, in accordance with some embodiments of the present disclosure. The system 200 may include, within the memory 106, a detection module 202, a feature and text extraction module 204, a data extraction module 206, a data analytics module 208, a data validation module 210, a CV module 212, a deep learning module 214, and a database 216.

The detection module 202 may receive a test report 218 from a data source. In some embodiments, the data source may be a test device (i.e., DUT). The test report 218 may be in any file format such as, but not limited to, image, PDF, docx, or xlsx. The test report 218 may include one or more report graphs and one or more report tables based on report data obtained from the data source.

The detection module 202 may invoke CV algorithms from the CV module 212 and deep learning model from the deep learning module 214. The detection module 202 may read (or detect) all the representations (such as symbols, data, lines, etc.) in the one or more report graphs with x axis and y axis. The test report 218 may also contain a summary table (which is included in the one or more report tables mentioned earlier) that includes a set of derived parameters (i.e., data derived using statistical methods such as average values, minimum values, maximum values, etc.). It should be noted that contents of each of the one or more report tables may be associated with a report graph or may represent independent metrics based on the need. The detection module 202 may send the detected report tables and report graphs with relevant information to the feature and text extraction module 204.

Further, the feature and text extraction module 204 may extract report data from the test report using the CV algorithms from the CV module 212 and the deep learning model from the deep learning module 214. The report data may include graph data (i.e., graph image data, such as symbols, colors, lines, etc.) and text data (i.e., graph text data and table text data). The feature and text extraction module 204 may extract the graph data from each of the one or more report graphs using the CV algorithms based on pixel information of a report graph and a set of predefined parameter labels. The graph data may correspond to a plurality of graph elements. By way of an example, the plurality of graph elements may include at least one of lines, colours, symbols, regions, scales of coordinate axes, and coordinates of a plurality of data points. Each type of the plurality of graph elements may correspond to a predefined parameter label. For example, a graph element of a ‘purple circle’ denoting a point on a report graph may correspond to a parameter label ‘average’.

In some embodiments, for each of the one or more report graphs in the test report 218, the feature and text extraction module 204 may identify, via the CV algorithms, threshold scales of each of the coordinate axes. The threshold scales may include a maximum scale and a minimum scale. Additionally, the feature and text extraction module 204 may extract text data from each of the one or more report tables and each of the one or more report graphs using the deep learning model. The text data may correspond to a plurality of table text elements (for example, contents of the report tables) and a plurality of graph text elements (for example, data labels, legends, axis titles, and graph title). Further, the feature and text extraction module 204 may send the graph data and the text data to the data validation module 210.

Contemporaneous to receiving the test report 218 by the detection module 202, the data extraction module 206 may receive a data dump file from the data source. The data dump file may include data dump 220 generated by the data source (that is populated in the data dump file). The data dump file may be in a file format, such as Comma-separated values (CSV), XLSX, or the like. By way of an example, for a medical device (e.g., blood glucose monitor), the data dump 220 may include information, such as patient name, ID, date range, device name, and all the readings captured for the patient. The data dump 220 may include values of all transactions recorded from the data source. The transactions may be related to date, time, and/or other metrics. In other words, the data dump 220 may include a whole dump of values (i.e., raw data) obtained directly from the data source. However, since the test report 218 is obtained from a section of the data dump 220 (i.e., report data), the data dump 220 needs to be filtered to obtain an extracted dataset corresponding to the report data for an accurate validation of the test report 218.

The feature and text extraction module 204 may identify a set of parameters (e.g., blood glucose levels, bolus, basal, insulin, etc.) and/or a set of derived parameters (e.g., average value of a parameter, median value, maximum value, minimum value, threshold values, etc.) mentioned in the report tables and report graphs of the test report 218 using the CV algorithms and the deep learning model. Additionally, the feature and text extraction module 204 may identify a date range (or time interval) of the report data in the test report 218 using the CV algorithms and the deep learning model. The feature and text extraction module 204 may then send the report data (i.e., the identified set of parameters, the set of derived parameters, and the date range) to the data extraction module 206.

To obtain the extracted dataset, the data extraction module 206 may pre-process the data dump 220 using a rule-based algorithm. The rule-based algorithm may enable filtering of data to obtain the extracted dataset for the identified set of parameters and/or the set of derived parameters within the identified date range. For example, if a parameter ‘blood glucose level’ is identified in a report graph and the date range (DD/MM/YYYY) is from ‘01/02/2025’ to ‘08/02/2025’, then the extracted dataset may include values of ‘blood glucose level’ in the data dump 220 within the date range of ‘01/02/2025’ to ‘08/02/2025’. For pre-processing, the data extraction module 206 may remove unwanted data (such as blank values, recent system time, forward ranges, backward ranges, etc.) from the data dump 220. Once the unwanted data is removed from the data dump 220, the extracted dataset is obtained. The data corresponding to the identified set of parameters in the extracted dataset includes a set of reference parameters. Further, the data extraction module 206 may send the extracted dataset to the data analytics module 208.

The data analytics module 208 may compute a set of derived reference parameters from the set of reference parameters obtained from the extracted dataset of the data dump 220. The set of derived reference parameters corresponds to the set of derived parameters obtained from the test report 218. In an embodiment, data analytics module 208 may store (or save) the report data (i.e., identified set of parameters and the identified set of derived parameters), the extracted dataset (i.e., the extracted set of reference parameters), and the computed data (i.e., the computed set of derived reference parameters) in the database 216. Further, the data validation module 210 may retrieve the report data, the extracted dataset, and the computed data from the database 216. In another embodiment, the database 216 may not be a part of the memory 106. In such an embodiment, the report data, the extracted dataset, and the computed data may not be stored and may directly be utilized in further processing by one or more modules in the memory 106.

The data validation module 210 may validate the report data through a comparison of the report data with the data dump 220 using the CV algorithms from the CV module 212 and the deep learning model from the deep learning module 214.

To validate the report data,, the data validation module 210 may validate, using the CV algorithms and the deep learning model, the graph data and the text data of the one or more report graphs based on a comparison of each of the plurality graph elements with a corresponding extracted dataset from the data dump 220, and a comparison of each of the plurality graph text elements with the corresponding extracted dataset from the data dump 220.

To validate the graph data and the text data of a report graph, the data validation module 210 may determine, via the CV algorithms and the deep learning model, coordinates and a circumference of each of a set of graph elements representative of a set of data points in the graph through a dynamic scale value to pixel value conversion of coordinate axes. It may be noted that an area enclosed by the circumference may be considered as a Region of Interest (RoI) by the data validation module 210. It may also be noted that the set of graph elements is a part of (i.e., included within) the plurality of graph elements. The set of graph elements may be symbols that are used to represent data points in the report graph. For example, in the report graph, a circle symbol may represent a value of the average blood glucose level for a time interval and a star symbol may represent a value of peak blood glucose level for the time interval.

To determine the coordinates of the set of graph elements, the data validation module 210 may identify, via the CV algorithms, a center of each of the set of graph elements. Further, the data validation module 210 may determine, via the CV algorithms and the deep learning model, the coordinates of each of the set of graph elements through a dynamic scale value to pixel value conversion of the coordinate axes. The dynamic scale value to pixel value conversion may include identifying, via the deep learning model, each of tick labels provided on a coordinate axis of the report graph to identify a scale of the coordinate axis. For example, a first tick label may be identified as ‘2’ and a second tick label may be identified as ‘4’. In some embodiments, the data validation module 210 may also estimate minor tick labels between the identified tick labels to accurately identify the coordinates associated with each of the set of graph elements in the report graph. For example, the data validation module 210 may estimate the minor tick labels ‘2.1’, ‘2.2’, ‘2.3’, …, ‘3.9’ between the identified tick labels ‘2’ and ‘4’. This may increase accuracy of determining the coordinates of a data point to a scale of 0.1, even when the actual scale of the report graph was 2.

Upon determining the coordinates of the set of graph elements, the data validation module 210 may determine, via the CV algorithms, whether each of a corresponding set of dump data points from the extracted dataset is within the RoI of each of the set of graph elements.

Further, the data validation module 210 may validate each of the set of graph elements based on the determining. By way of an example, a data point may be represented as a circle on the report graph. The data validation module 210 may determine an area enclosed within the circumference of the circle via the CV algorithms. The area enclosed is taken as the RoI for validation. Then, for a successful validation of the data point, a dump data point (for the corresponding data point), when plotted on the report graph should be located within the determined circumference (i.e., the RoI) of the data point. In other words, coordinates of the dump data point should be located within the coordinate range determined for the circumference of the circle of the data point.

Additionally, to validate the report data, the data validation module 210 may validate the text data of the one or more tables based on a comparison of the set of reference parameters with the corresponding set of parameters, and the set of derived reference parameters with the corresponding set of derived parameters. For example, if an average blood glucose level is provided as ‘10 mmol/L’ in the test report 218, and the average blood glucose level is computed as ‘11 mmol/L’ from the extracted dataset, the data validation module 210 may establish the validation for the average blood glucose level as unsuccessful (or failed validation).

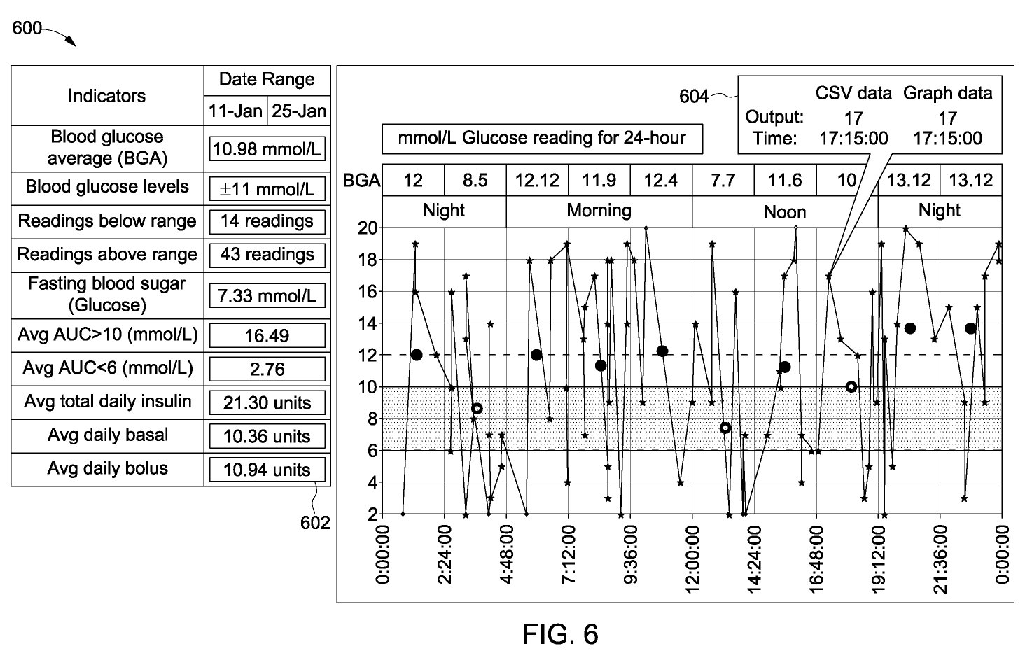

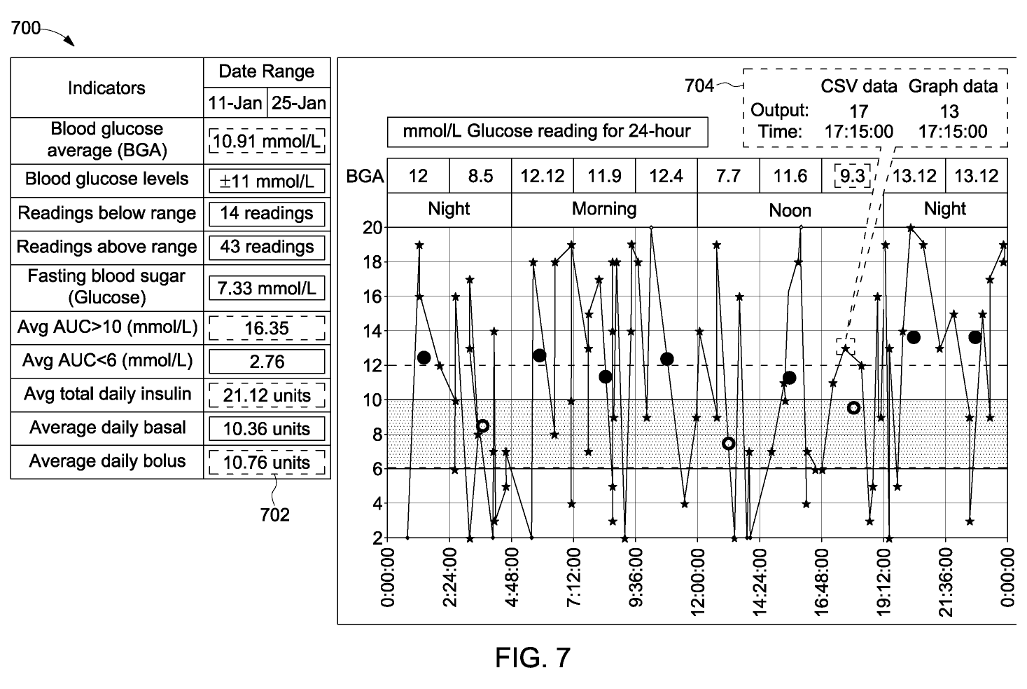

Further, upon validating the report data, the data validation module 210 may generate a validation report 222. The validation report 222 may include the test report 218 and a result of the comparison of each element of the report data with a corresponding element of the data dump 220. To generate the validation report 222, the data validation module 210 may mark a compared element of the test report 218 with a first unique marking when the result of the comparison is indicative of a failed comparison. Alternatively, when the compared element is a table text element, the data validation module 210 may mark the compared element of the test report 218 with a second unique marking when the result of the comparison is indicative of a successful comparison. By way of an example, the first unique marking may be a red colored box enclosing the compared element or a red color highlight over the compared element. Similarly, the second unique marking may be a green colored box enclosing the compared element or a green color highlight over the compared table text element. It should be noted that for graph elements and graph text elements, only the first unique marking will be shown when the validation is failed, and when the validation is successful, no marking will be shown. Further, the data validation module 210 may render, via a Graphical User Interface (GUI), the validation report 222 on a user device. The rendering may further include displaying the result of the comparison corresponding to a user selected element on the validation report 222. The validation report 222 is explained in greater detail in conjunction with FIGS. 6 and 7.

It should be noted that all such modules 206 – 214 may be represented as a single module or a combination of different modules. Further, as will be appreciated by those skilled in the art, each of the modules 206 – 214 may reside, in whole or in parts, on one device or multiple devices in communication with each other. In some embodiments, each of the modules 206 – 214 may be implemented as dedicated hardware circuit comprising custom application-specific integrated circuit (ASIC) or gate arrays, off-the-shelf semiconductors such as logic chips, transistors, or other discrete components. Each of the modules 206 – 214 may also be implemented in a programmable hardware device such as a field programmable gate array (FPGA), programmable array logic, programmable logic device, and so forth. Alternatively, each of the modules 206 – 214 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for validating test reports. For example, exemplary system 100 and the associated computing device 102 may validate test reports by the processes discussed herein. As will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application-specific integrated circuits (ASICs) configured to perform some or all of the processes described herein may be included in the one or more processors on the system 100.

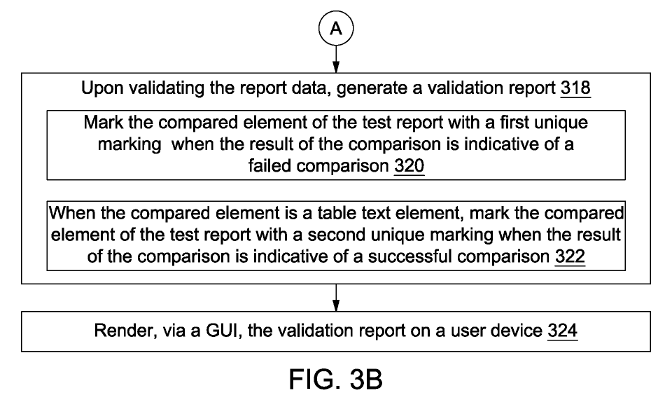

Referring now to FIGS. 3A and 3B, an exemplary process 300 for validating test reports is depicted via a flowchart, in accordance with some embodiments of the present disclosure. The process 300 may be implemented by the computing device 102 of the system 100. The process 300 may include receiving a test report (for example, the test report 218) and a corresponding data dump file from a data source (for example, a test device), at step 302. The data dump file may include data dump (for example, the data dump 220) generated by the data source. The test report may include one or more report graphs and one or more report tables.

Further, the process 300 may include extracting report data from the test report using CV algorithms and a deep learning model, at step 304. The step 304 may include steps 306 and 308. The process 300 may include extracting graph data from each of the one or more report graphs using the CV algorithms based on pixel information of a report graph and a set of predefined parameter labels, at step 306. The graph data may correspond to a plurality of graph elements. Each type of the plurality of graph elements may correspond to a predefined parameter label. Further, the process 300 may include extracting text data from each of the one or more report tables and each of the one or more report graphs using the deep learning model, at step 308. The text data may correspond to a plurality of table text elements and a plurality of graph text elements. Thereafter, the process 300 may proceed to step 310.

Further, the process 300 may include validating the report data through a comparison with the data dump using the CV algorithms and the deep learning model, at step 310. The step 310 may include a first sub-process of step 312, and a second sub-process of steps 314 and 316. In the first sub-process, the process 300 may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump, at step 312. The extracted dataset corresponds to the report data.

In the second sub-process, the process 300 may include computing a set of derived reference parameters from a set of reference parameters obtained from the extracted dataset of the data dump, at step 314. The set of reference parameters may correspond to a set of parameters obtained from the plurality of table text elements. The set of derived reference parameters may correspond to a set of derived parameters obtained from the plurality of table text elements.

Further, the process 300 may include validating, using the deep learning model, the text data of the one or more tables based on a comparison of the set of reference parameters with the corresponding set of parameters, and the set of derived reference parameters with the corresponding set of derived parameters, at step 316. Thereafter, the process 300 may proceed to step 318. Upon validating the report data, the process 300 may include generating a validation report (for example, the validation report 222), at step 318. The validation report may include the test report and a result of the comparison of each element of the report data with a corresponding element of the data dump. For each compared element, the step 318 may include one of steps 320 or 322.

For each compared element, the process 300 may include marking the compared element of the test report with a first unique marking (e.g., red colored box) when the result of the comparison is indicative of a failed comparison, at step 320. Alternatively, when the compared element is a table text element, for each compared element, the process 300 may include marking the compared element of the test report with a second unique marking (e.g., green colored box) when the result of the comparison is indicative of a successful comparison, at step 322. Thereafter, the process 300 may proceed to step 324. The process 300 may include rendering, via a GUI, the validation report on a user device, at step 324. The step 324 may include displaying the result of the comparison corresponding to a user selected element on the validation report.

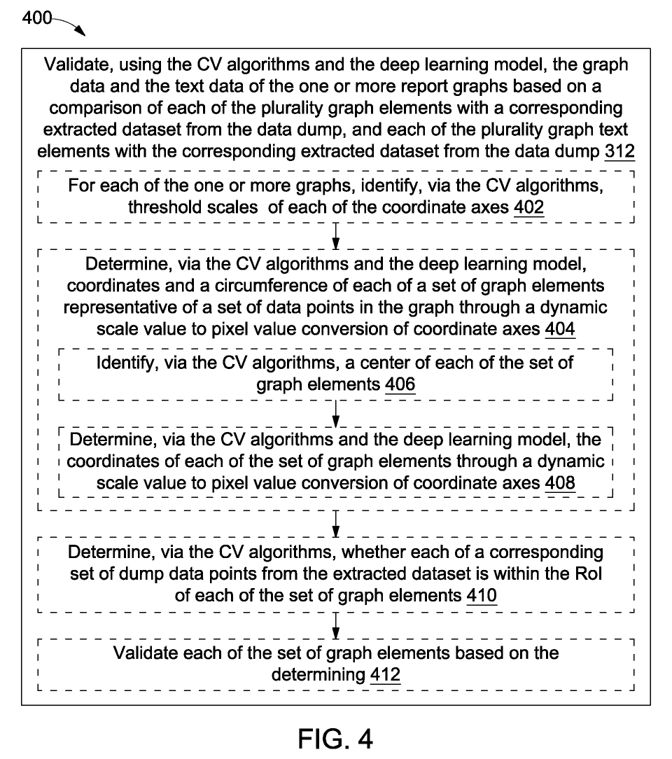

Referring now to FIG. 4, an exemplary process 400 for validating graph data and text data in report graphs is depicted via a flowchart, in accordance with some embodiments of the present disclosure. The process 400 may be implemented by the computing device 102. The process 400 may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump, at step 312. The step 312 may include steps 402, 404, 406, 408, 410, and 412.

For each of the one or more report graphs, the process 400 may include identifying, via the CV algorithms, threshold scales of each of the coordinate axes, at step 402. The threshold scales may include a maximum scale and a minimum scale. Further, for each graph of the one or more report graphs, the process 400 may include determining, via the CV algorithms and the deep learning model, coordinates and a circumference of each of a set of graph elements representative of a set of data points in the graph through a dynamic scale value to pixel value conversion of coordinate axes, at step 404. An area enclosed by the circumference is an RoI. The set of graph elements is a part (i.e., a subset) of the plurality of graph elements. The step 404 may include steps 406 and 408. The process 400 may include identifying, via the CV algorithms, a center of each of the set of graph elements, at step 406. Further, the process 400 may include determining, via the CV algorithms and the deep learning model, the coordinates of each of the set of graph elements through a dynamic scale value to pixel value conversion of coordinate axes, at step 408. Thereafter, the process 400 may proceed to step 410.

Further, the process 400 may include determining, via the CV algorithms, whether each of a corresponding set of dump data points from the extracted dataset is within the RoI of each of the set of graph elements, at step 410. Further, the process 400 may include validating each of the set of graph elements based on the determining, at step 412.

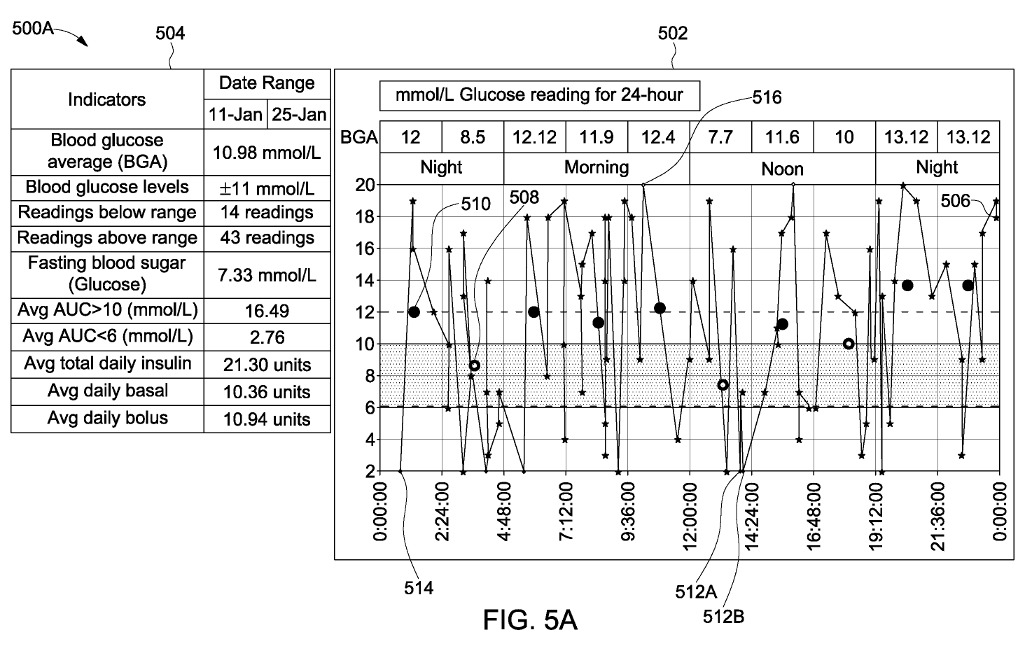

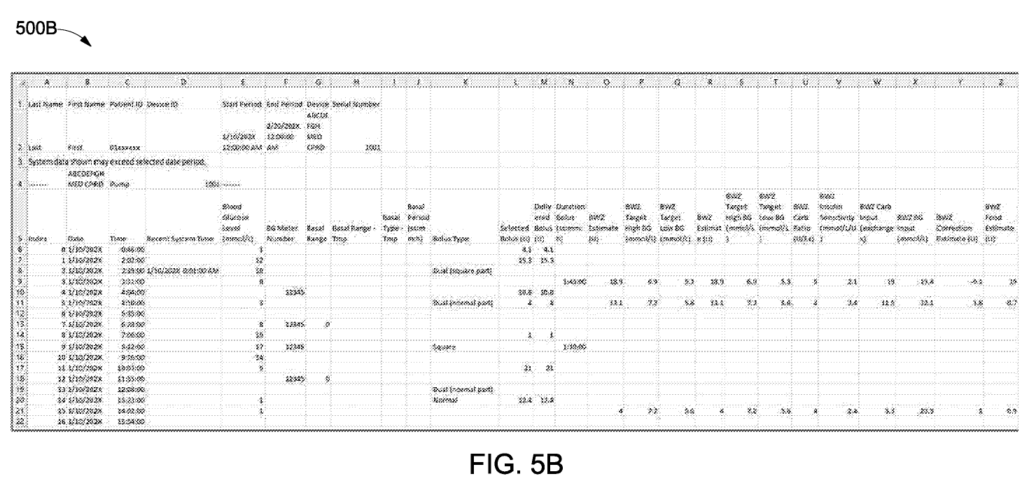

Referring now to FIG. 5A, an exemplary test report 500A is illustrated, in accordance with some embodiments of the present disclosure. The exemplary test report 500A may be analogous to the test report 218. The exemplary test report 500A may include one or more report graphs (for example, a graph 502) and one or more report tables (for example, a table 504). By way of an example, the test report 500A may be based on blood glucose readings for a patient captured by a data source for a date range of 11 January 2025 to 25 January 2025 (i.e., 15 days). In other words, the report data for the test report 500A may include data from data dump within this date range.

The graph 502 may include an x-axis representing time ranges (morning, noon, and night) and a y-axis representing blood glucose values (scale of 2-20 mmol/L). A value of blood glucose level observed within a time range is represented by a star (e.g., a star 506) when the value is within the scale (i.e., between 2-20 mmol/L). Additionally, a threshold range of 6-10 mmol/L may be highlighted in the graph 502. A value of an average blood glucose level for the date range of 15 days for a given time range is represented by a doughnut circle (e.g., a doughnut circle 508) when the value falls within the threshold range. In other words, when the value of the average blood glucose level is between 6 to 10 mmol/L, the value is represented by a doughnut circle. Alternatively, when the value is beyond the threshold range, the value is represented by a filled circle (e.g., a filled circle 510).

When the values of blood glucose level are less than 2 mmol/L (i.e., below the scale of y-axis), the values are represented on the x-axis (i.e., y=2) with a first colored rhombus symbol (e.g., a first colored rhombus 512A, a first colored rhombus 512B, and a first colored rhombus 514). Similarly, when the values of blood glucose level are more than 20 mmol/L (i.e., above the scale of y-axis), the values are represented at y=20 with a second colored rhombus symbol (e.g., a second colored rhombus 516).

In some scenarios, two or more data points may overlap with each other. For example, the first colored rhombus 512A and the first colored rhombus 512B overlap with each other. The CV algorithms may accurately determine presence of two distinct data points in such an overlapping scenario. This is because the CV algorithms determine coordinates of a center of a graph element (such as a symbol representing a data point). Thus, even when at least a minimal part of the overlapping symbols is non-overlapping (i.e., the symbols include at least one minimal non-overlapping portion), the CV algorithms may accurately identify the symbols as distinct graph elements. Similarly, there may be scenarios when two or more different shapes may overlap with each other. For example, a star symbol may be overlapping with a filled circle symbol. The CV algorithms may again accurately identify such shapes as distinct graph elements.

Additionally, the graph 502 may include blood glucose average (BGA) values presented in textual format above the y-axis for each time range. These BGA values can be validated in the graph 502 area through a comparison with the coordinates of the filled circles or the doughnut circles. It should be noted that the BGA values in textual format may be identified using the deep learning model.

The table 504 may be a summary table for the date range of 15 days. The table 504 may include information on key parameters values (i.e., the set of derived parameters) with their measured units to get user/patient condition. These values are derived using mathematical formulations using the collected data (i.e., the dump data).

Referring now to FIG. 5B, exemplary dump data 500B is illustrated, in accordance with some embodiments of the present disclosure. The dump data 500B may be analogous to the data dump 220. The dump data 500B includes the data generated by the pump/test device (i.e., the data source) and is populated in a predefined format. By way of an example, the dump data 500B may include information such as patient name, ID, date range, device name, and all the readings captured about the patient. This dump data 500B may also include blank values, recent system time (forward and backward ranges), which need to be excluded (by pre-processing). A statistical analysis is applied on the BG values for the date, time ranges populated in the file to calculate the average BG values. Likewise, bolus, basal, insulin etc., readings are used to calculate the threshold values by applying respective computations. The dump data 500B may include information on additional parameters and based on the report generation, the required parameters may be considered. All the calculations performed for a parameter may be saved for final verifications.

Referring now to FIG. 6, an exemplary validation report 600 with successfully validated report data is illustrated, in accordance with some embodiments of the present disclosure. FIG. 6 is explained in conjunction with FIG. 5. The validation report 600 may be analogous to the validation report 222. The validation report 600 may be generated upon validation of the test report 500A by the data validation module 210. Each graph element may be presented with a bounding box around the graph element. At least one feature of the bounding box may be indicative of validation result for the graph element. The at least one feature may be a distinct color (e.g., green for successful validation and red for unsuccessful validation), distinct boundary, etc. For example, a bounding box 602 around a value for average daily bolus may indicate that the value is successfully validated. In other words, the bounding box 602 indicates that the value in the test report 500A is same as the value for average daily bolus computed from the data dump.

Additionally, a callout (such as a callout 604) may be presented when a user interacts with a graph element in the validation report 600. The interaction may include, but may not be limited to, hovering a cursor over the graph element or clicking on the graph element. The callout 604 may include details of validation, for example, a comparison between the dump data and the graph data corresponding to the graph element. In an embodiment, the callout 604 and the bounding box 602 may be marked with a second unique marking (e.g., green color).

Referring now to FIG. 7, an exemplary validation report 700 with some unsuccessfully validated report data is illustrated, in accordance with some embodiments of the present disclosure. FIG. 7 is explained in conjunction with FIG. 5. The validation report 700 may be analogous to the validation report 222. The validation report 700 may be generated upon validation of the test report 500A by the data validation module 210. Each graph element may be presented with a bounding box around the graph element.

At least one feature of the bounding box may be indicative of validation result for the graph element. The at least one feature may be a distinct color (e.g., green for successful validation and red for unsuccessful validation), distinct boundary, etc. For example, a bounding box 702 around a value for average daily bolus may indicate that the value is unsuccessfully validated. In other words, the bounding box 702 indicates that the value in the test report 500A is different from the value for average daily bolus computed from the data dump.

Additionally, a callout (such as a callout 704) may be presented when a user interacts with a graph element in the validation report 700. The interaction may include, but may not be limited to, hovering a cursor over the graph element or clicking on the graph element. The callout 704 may include details of validation, for example, a comparison between the dump data and the graph data corresponding to the graph element. In an embodiment, the callout 704 and the bounding box 702 may be marked with a first unique marking (e.g., red color).

As will be also appreciated, the above-described techniques may take the form of computer or controller-implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer.

Thus, the disclosed method and system try to overcome the technical problem of validating test reports. The method and system may seamlessly integrate with any automation framework and customer-specific test infrastructure. The method and system may reduce the overall testing cycle time by about 30% to 40% compared to manual testing efforts. The method and system may provide an increased automation coverage by about 10% to 15% when compared to traditional test automation frameworks. The method and system may increase testing speed by about 2 to 2.5 times.

As will be appreciated by those skilled in the art, the techniques described in the various embodiments discussed above are not routine, or conventional, or well understood in the art. The techniques discussed above provide for validating test reports. The techniques may first receive a test report and a corresponding data dump file from a data source. The data dump file may include data dump generated by the data source. The test report may include one or more report graphs and one or more report tables based on the report data obtained from the data dump. The techniques may then extract the report data from the test report using CV algorithms and a deep learning model. Extracting the report data may include extracting graph data from each of the one or more report graphs using the CV algorithms based on pixel information of a report graph and a set of predefined parameter labels. The graph data may correspond to a plurality of graph elements. Each type of the plurality of graph elements may correspond to a predefined parameter label. Extracting the report data may further include extracting text data from each of the one or more report tables and each of the one or more report graphs using the deep learning model. The text data may correspond to a plurality of table text elements and a plurality of graph text elements. The techniques may then validate the report data through a comparison with the data dump using the CV algorithms and the deep learning model. Validating the report data may include validating, using the CV algorithms and the deep learning model, the graph data and the text data of the one or more report graphs based on a comparison of each of the plurality graph elements with a corresponding extracted dataset from the data dump, and each of the plurality graph text elements with the corresponding extracted dataset from the data dump.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for validating test reports. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for validating test reports, the method comprising:
receiving a test report and a corresponding data dump file from a data source, wherein the data dump file comprises data dump generated by the data source, and wherein the test report comprises one or more report graphs and one or more report tables based on report data obtained from the data dump;
extracting the report data from the test report using Computer Vision (CV) algorithms and a deep learning model, and wherein extracting the report data comprises:
extracting graph data from each of the one or more report graphs using the CV algorithms based on pixel information of a report graph and a set of predefined parameter labels, wherein the graph data corresponds to a plurality of graph elements, and wherein each type of the plurality of graph elements corresponds to a predefined parameter label; and
extracting text data from each of the one or more report tables and each of the one or more report graphs using the deep learning model, wherein the text data corresponds to a plurality of table text elements and a plurality of graph text elements; and
validating the report data through a comparison with the data dump using the CV algorithms and the deep learning model, wherein validating the report data comprises:
validating, using the CV algorithms and the deep learning model, the graph data and the text data of the one or more report graphs based on a comparison of:
each of the plurality graph elements with a corresponding extracted dataset from the data dump, wherein the extracted dataset corresponds to the report data, and
each of the plurality graph text elements with the corresponding extracted dataset from the data dump.

2. The method of claim 1, wherein validating the report data further comprises:
computing a set of derived reference parameters from a set of reference parameters obtained from the extracted dataset of the data dump, wherein the set of reference parameters corresponds to a set of parameters obtained from the plurality of table text elements, and wherein the set of derived reference parameters corresponds to a set of derived parameters obtained from the plurality of table text elements; and
validating, using the deep learning model, the text data of the one or more tables based on a comparison of the set of reference parameters with the corresponding set of parameters, and the set of derived reference parameters with the corresponding set of derived parameters.

3. The method of claim 1, wherein validating the graph data and the text data of the one or more report graphs comprises:
for each graph of the one or more report graphs,
determining, via the CV algorithms and the deep learning model, coordinates and a circumference of each of a set of graph elements representative of a set of data points in the graph through a dynamic scale value to pixel value conversion of coordinate axes, wherein an area enclosed by the circumference is a Region of Interest (RoI), and wherein the set of graph elements is a part of the plurality of graph elements;
determining, via the CV algorithms, whether each of a corresponding set of dump data points from the extracted dataset is within the RoI of each of the set of graph elements; and
validating each of the set of graph elements based on the determining.

4. The method of claim 3, wherein determining the coordinates of each of a set of graph elements representative of the set of data points comprises:
identifying, via the CV algorithms, a center of each of the set of graph elements; and
determining, via the CV algorithms and the deep learning model, the coordinates of each of the set of graph elements through the dynamic scale value to pixel value conversion of coordinate axes.

5. The method of claim 4, wherein validating the graph data and the text data of the one or more report graphs comprises:
for each of the one or more report graphs, identifying, via the CV algorithms, threshold scales of each of the coordinate axes, wherein the threshold scales comprise a maximum scale and a minimum scale.

6. The method of claim 1, further comprising, upon validating the report data, generating a validation report, wherein the validation report comprises the test report and a result of the comparison of each element of the report data with a corresponding element of the data dump.

7. The method of claim 6, wherein generating the validation report comprises:
for each compared element, one of
marking the compared element of the test report with a first unique marking when the result of the comparison is indicative of a failed comparison; or
when the compared element is a table text element, marking the compared element of the test report with a second unique marking when the result of the comparison is indicative of a successful comparison.

8. The method of claim 6, further comprising rendering, via a Graphical User Interface (GUI), the validation report on a user device, wherein the rendering further comprises displaying the result of the comparison corresponding to a user selected element on the validation report.

9. The method of claim 1, wherein:
the plurality of graph elements comprises at least one of lines, colours, symbols, regions, scales of coordinate axes, and coordinates of a plurality of data points, and
the plurality of graph text elements comprises data labels, legends, axis titles, and graph title.

10. A system for validating test reports, the system comprising:
a processor; and
a memory communicatively coupled to the processor, wherein the memory stores processor instructions, which when executed by the processor, cause the processor to:
receive a test report and a corresponding data dump file from a data source, wherein the data dump file comprises data dump generated by the data source, and wherein the test report comprises one or more report graphs and one or more report tables based on report data obtained from the data dump;
extract the report data from the test report using CV algorithms and a deep learning model, and wherein to extract the report data, the processor instructions, when executed, cause the processor to:
extract graph data from each of the one or more report graphs using the CV algorithms based on pixel information of a report graph and a set of predefined parameter labels, wherein the graph data corresponds to a plurality of graph elements, and wherein each type of the plurality of graph elements corresponds to a predefined parameter label; and
extract text data from each of the one or more report tables and each of the one or more report graphs using the deep learning model, wherein the text data corresponds to a plurality of table text elements and a plurality of graph text elements; and
validate the report data through a comparison with the data dump using the CV algorithms and the deep learning model, wherein to validate the report data, the processor instructions, when executed, cause the processor to:
validate, using the CV algorithms and the deep learning model, the graph data and the text data of the one or more report graphs based on a comparison of:
each of the plurality graph elements with a corresponding extracted dataset from the data dump, wherein the extracted dataset corresponds to the report data, and
each of the plurality graph text elements with the corresponding extracted dataset from the data dump.

11. The system of claim 10, wherein to validate the report data, the processor instructions, on execution, cause the processor to:
compute a set of derived reference parameters from a set of reference parameters obtained from the extracted dataset of the data dump, wherein the set of reference parameters corresponds to a set of parameters obtained from the plurality of table text elements, and wherein the set of derived reference parameters corresponds to a set of derived parameters obtained from the plurality of table text elements; and
validate, using the deep learning model, the text data of the one or more tables based on a comparison of the set of reference parameters with the corresponding set of parameters, and the set of derived reference parameters with the corresponding set of derived parameters.

12. The system of claim 10, wherein to validate the graph data and the text data of the one or more report graphs, the processor instructions, on execution, cause the processor to:
for each graph of the one or more report graphs,
determine, via the CV algorithms and the deep learning model, coordinates and a circumference of each of a set of graph elements representative of a set of data points in the graph through a dynamic scale value to pixel value conversion of coordinate axes, wherein an area enclosed by the circumference is an RoI, and wherein the set of graph elements is a part of the plurality of graph elements;
determine, via the CV algorithms, whether each of a corresponding set of dump data points from the extracted dataset is within the RoI of each of the set of graph elements; and
validate each of the set of graph elements based on the determining.

13. The system of claim 12, wherein to determine the coordinates of each of a set of graph elements representative of the set of data points, the processor instructions, on execution, cause the processor to:
identify, via the CV algorithms, a center of each of the set of graph elements; and
determine, via the CV algorithms and the deep learning model, the coordinates of each of the set of graph elements through a dynamic scale value to pixel value conversion of coordinate axes.

14. The system of claim 13, wherein to validate the graph data and the text data of the one or more report graphs, the processor instructions, on execution, cause the processor to:
for each of the one or more report graphs, identify, via the CV algorithms, threshold scales of each of the coordinate axes, wherein the threshold scales comprise a maximum scale and a minimum scale.

15. The system of claim 10, wherein the processor instructions, on execution, further cause the processor to, upon validating the report data, generate a validation report, wherein the validation report comprises the test report and a result of the comparison of each element of the report data with a corresponding element of the data dump.

16. The system of claim 15, wherein to generate the validation report, the processor instructions, on execution, cause the processor to:
for each compared element,
mark the compared element of the test report with a first unique marking when the result of the comparison is indicative of a failed comparison; and
when the compared element is a table text element, mark the compared element of the test report with a second unique marking when the result of the comparison is indicative of a successful comparison.

17. The system of claim 15, wherein the processor instructions, on execution, further cause the processor to render, via a GUI, the validation report on a user device, wherein to render, the processor instructions, on execution, cause the processor to display the result of the comparison corresponding to a user selected element on the validation report.

18. The system of claim 10, wherein:
the plurality of graph elements comprises at least one of lines, colours, symbols, regions, scales of coordinate axes, and coordinates of a plurality of data points, and
the plurality of graph text elements comprises data labels, legends, axis titles, and graph title.

19. A non-transitory computer-readable medium storing computer-executable instructions for validating test reports, the computer-executable instructions configured for:
receiving a test report and a corresponding data dump file from a data source, wherein the data dump file comprises data dump generated by the data source, and wherein the test report comprises one or more report graphs and one or more report tables based on report data obtained from the data dump;
extracting report data from the test report using Computer Vision (CV) algorithms and a deep learning model, and wherein extracting the report data comprises:
extracting graph data from each of the one or more report graphs using the CV algorithms based on pixel information of a report graph and a set of predefined parameter labels, wherein the graph data corresponds to a plurality of graph elements, and wherein each type of the plurality of graph elements corresponds to a predefined parameter label; and
extracting text data from each of the one or more report tables and each of the one or more report graphs using the deep learning model, wherein the text data corresponds to a plurality of table text elements and a plurality of graph text elements; and
validating the report data through a comparison with the data dump using the CV algorithms and the deep learning model, wherein validating the report data comprises:
validating, using the CV algorithms and the deep learning model, the graph data and the text data of the one or more report graphs based on a comparison of:
each of the plurality graph elements with a corresponding extracted dataset from the data dump, wherein the extracted dataset corresponds to the report data, and
each of the plurality graph text elements with the corresponding extracted dataset from the data dump.

20. The non-transitory computer-readable medium of claim 19, wherein for validating the graph data and the text data of the one or more report graphs, the computer-executable instructions are configured for:
for each graph of the one or more report graphs,
determining, via the CV algorithms and the deep learning model, coordinates and a circumference of each of a set of graph elements representative of a set of data points in the graph through a dynamic scale value to pixel value conversion of coordinate axes, wherein an area enclosed by the circumference is an RoI, and wherein the set of graph elements is a part of the plurality of graph elements;
determining, via the CV algorithms, whether each of a corresponding set of dump data points from the extracted dataset is within the RoI of each of the set of graph elements; and
validating each of the set of graph elements based on the determining.
